(19) United States
(12) Patent Application Publication
(10) Pub. No.: US 2017/0099629 A1
(43) Pub. Date: Apr. 6, 2017

(54) NETWORK SEARCH METHOD AND APPARATUS

(71) Applicant: HUAWEI DEVICE CO., LTD., Shenzhen, Guangdong (CN)

(72) Inventors: Zhenyu LIU, Wuhan (CN); Shoucheng WANG, Wuhan (CN)

(73) Assignee: HUAWEI DEVICE CO., LTD., Shenzhen, Guangdong (CN)

(21) Appl. No.: 15/126,941

(22) PCT Filed: Mar. 18, 2014
(86) PCT No.: PCT/CN2014/073563

§ 371 Date: Sep. 16, 2016

(51) Int. Cl. H04W 48/16; H04W 52/02; H04L 12/801; H04W 4/02

(52) U.S. Cl. CPC H04W 48/16; H04W 4/026; H04W 52/0216; H04L 47/29

(57) ABSTRACT

A network search method where the method includes acquiring, by a terminal, geographical location information of the terminal, and determining a geographical environment in which the terminal is located; and setting a network search time interval corresponding to the geographical environment. Therefore, a network search time interval may be set flexibly according to a different geographical environment in which the terminal is located. Hence, power consumption of a battery of the terminal can be effectively reduced, and further a standby time of the terminal is effectively increased.

### CROSS-REFERENCE TO RELATED APPLICATIONS

This application is a National Stage of International Application No. PCT/CN2014/073563, filed on Mar. 18, 2014, which is hereby incorporated by reference in its entireties.

### TECHNICAL FIELD

The present disclosure relates to the communications field, and in particular, to a network search method for a terminal and a terminal that uses the network search method.

### BACKGROUND

Currently, a general network search process of a terminal is:

s1: After a terminal loses a network connection, the terminal fails to detect a wireless link; then the terminal starts a network search process.

s2: If no network is found in step s1, a network search is initiated again n minutes later.

s3: If the network search fails in step s2, a network search operation is performed again 2*n minutes later.

In the network search solution, no matter what a geographical environment in which the terminal is located is like (for example, the terminal is located in a high mountain, or the terminal is located in a city), before a network is found, the terminal keeps searching for a network repeatedly according to a fixed network-search period. In this case, for areas such as high mountains or seas generally with a relatively weak network signal or hardly with a network signal, using the solution undoubtedly causes a waste of battery power. To sum up, in the network search solution in the prior art, frequent network searches cause relatively high power consumption, and further cause particularly fast electricity consumption of the terminal.

### SUMMARY

In view of this, the present disclosure provides a network search method for a terminal and a terminal, so that a network search time interval can be flexibly set according to a geographical environment in which the terminal is located, and a standby time of the terminal can be effectively controlled.

A first aspect of the present disclosure provides a network search method for a terminal, and the method may include:

acquiring, by a terminal, geographical location information of the terminal, and determining geographical environment in which the terminal is located according to the acquired geographical location information; and

setting, by the terminal, a network search time interval corresponding to the geographical environment according to the determined geographical environment.

With reference to the first aspect, in a first feasible implementation manner, the acquiring, by a terminal, geographical location information of the terminal, and determining, according to the acquired geographical location information, geographical environment in which the terminal is located includes:

acquiring, by the terminal, the geographical location information of the terminal by using a positioning system; and

determining, by the terminal, the geographical environment in which the terminal is located according to the acquired geographical location information and a map that is stored locally on the terminal.

With reference to the first feasible implementation manner of the first aspect, in a second feasible implementation manner, the geographical location information includes latitude and longitude information, or geographical coordinates; and

the determining, by the terminal, the geographical environment in which the terminal is located according to the acquired geographical location information and a map that is stored locally on the terminal comprises:

inputting, by the terminal, the latitude and longitude information, or the geographical coordinates into the map that is stored locally on the terminal, and determining the geographical environment in which the terminal is located according to a geographical name displayed on the locally stored map.

With reference to the first aspect to the second feasible implementation manner of the first aspect, in a third feasible implementation manner, the setting, by the terminal, a network search time interval corresponding to the geographical environment according to the determined geographical environment includes:

setting the network search time interval for the terminal to be greater than a first time threshold when the geographical environment belongs to a first geographical environment in which a network signal is less than a preset threshold; and/or

setting the network search time interval for the terminal to be less than a second time threshold when the geographical environment belongs to a second geographical environment in which a network signal is greater than a preset threshold.

With reference to the first aspect to the third feasible implementation manner of the first aspect, in a fourth feasible implementation manner, the method further includes:

performing network search operation when the terminal detects that backlight of screen is activated.

A second aspect of the present disclosure provides a terminal, and the terminal may include:

a positioning module, configured to acquire geographical location information of the terminal, and determine geographical environment in which the terminal is located according to the acquired geographical location information; and

a period setting module, configured to set a network search time interval corresponding to the geographical environment according to the geographical environment determined by the positioning module.

With reference to the second aspect, in a first feasible implementation manner, the positioning module includes:

a location information acquiring module, configured to acquire geographical location information of the terminal by using a positioning system; and

a geographical environment determining module, configured to determine the geographical environment in which the terminal is located, according to the geographical location information acquired by the location information acquiring module and a map that is stored locally on the terminal.

With reference to the first feasible implementation manner of the second aspect, in a second feasible implementation manner, the geographical location information includes latitude and longitude information, or geographical coordinates; and

the geographical environment determining module is specifically configured to input the latitude and longitude information, or the geographical coordinates into the map that is stored locally on the terminal, and determine the geographical environment in which the terminal is located according to a geographical name displayed on the locally stored map.

With reference to the second aspect to the second feasible implementation manner of the second aspect, in a third feasible implementation manner, the period setting module includes:

a determining module, configured to determine whether the geographical environment belongs to a first geographical environment in which a network signal is less than a preset threshold, and/or configured to determine whether the geographical environment belongs to a second geographical environment in which a network signal is greater than a preset threshold; and/or

a setting module, configured to set the network search time interval for the terminal to be greater than a first time threshold when the geographical environment belongs to the first geographical environment; and set the network search time interval for the terminal to be less than a second time threshold when the geographical environment belongs to the second geographical environment.

With reference to the second aspect to the third feasible implementation manner of the second aspect, in a fourth feasible implementation manner, the terminal further includes:

an emergency network-search module, configured to perform a network search operation when the terminal detects that backlight of screen is activated.

A third aspect of the present disclosure provides a terminal, and the terminal may include a locator, a processor, and a memory;

wherein the locator, the processor, wherein the memory are coupled to each other using a bus; wherein the locator is configured to acquire geographical location information of the terminal; and

the processor is configured to perform the following operations stored in the memory: determine geographical environment in which the terminal is located according to the acquired geographical location information; and set a network search time interval corresponding to the geographical environment according to the determined geographical environment.

With reference to the third aspect, in a first feasible implementation manner,

the processor is further configured to determine the geographical environment in which the terminal is located, according to the geographical location information acquired by the locator and a map that is stored in the memory.

With reference to the first feasible implementation manner of the third aspect, in a second feasible implementation manner, the geographical location information includes latitude and longitude information, or geographical coordinates; and

the processor is further configured to acquire a geographical name that is on the map corresponding to the latitude and longitude information according to the latitude and longitude information and the map that is stored in the memory, and determine the geographical environment in which the terminal is located according to the geographical name; or

the processor is further configured to acquire a geographical name that is on the map corresponding to the geographical coordinates according to the geographical coordinates and the map that is stored in the memory, and determines the geographical environment in which the terminal is located according to the geographical name.

With reference to the third aspect to the second feasible implementation manner of the third aspect, in a third feasible implementation manner, that the processor

the processor is further configured to determine whether the geographical environment belongs to a first geographical environment in which a network signal is less than a preset threshold, and/or the processor is further configured to determine whether the geographical environment belongs to a second geographical environment in which a network signal is greater than a preset threshold; and/or

set the network search time interval for the terminal to be greater than a first time threshold when the geographical environment belongs to the first geographical environment; and set the network search time interval for the terminal to be less than a second time threshold when the geographical environment belongs to the second geographical environment.

With reference to the third aspect to the third feasible implementation manner of the third aspect, in a fourth feasible implementation manner, the terminal further includes a screen, and the processor is further configured to perform a network search operation when backlight of the screen is activated.

A fourth aspect of the present disclosure provides a computer storage medium, where the computer storage medium may store a program, and when the program is executed, some or all steps of the method according to the embodiments of the present disclosure may be included.

It can be seen from the above that in some feasible implementation manners of the present disclosure, a terminal acquires geographical location information of the terminal, and determines, according to the acquired geographical location information, a geographical environment in which the terminal is located; and the terminal sets, according to the determined geographical environment, a network search time interval corresponding to the geographical environment. Therefore, a network search time interval may be set flexibly according to a different geographical environment in which the terminal is located. Further, a relatively long network search time interval may be set when the geographical environment in which the terminal is located is a geographical environment with a relatively weak network signal; and a relatively short network search time interval may be set when the geographical environment in which the terminal is located is a geographical environment with a relatively strong network signal. Therefore, according to embodiments of the present disclosure, power consumption of a battery of the terminal can be effectively reduced, and further a standby time of the terminal is effectively increased.

### BRIEF DESCRIPTION OF DRAWINGS

FIG. 1 is a schematic flowchart of an embodiment of a network search method for a terminal according to the present disclosure;

FIG. 2 is a schematic diagram of structural composition of an embodiment of a terminal according to the present disclosure;

FIG. 3 is a schematic diagram of structural composition of an embodiment of a positioning module 21 according to the present disclosure;

FIG. 4 is a schematic diagram of structural composition of an embodiment of a period setting module 22 according to the present disclosure;

FIG. 5 is a schematic diagram of structural composition of another embodiment of a terminal according to the present disclosure; and

FIG. 6 is a schematic diagram of structural composition of another embodiment of a terminal according to the present disclosure.

### DESCRIPTION OF EMBODIMENTS

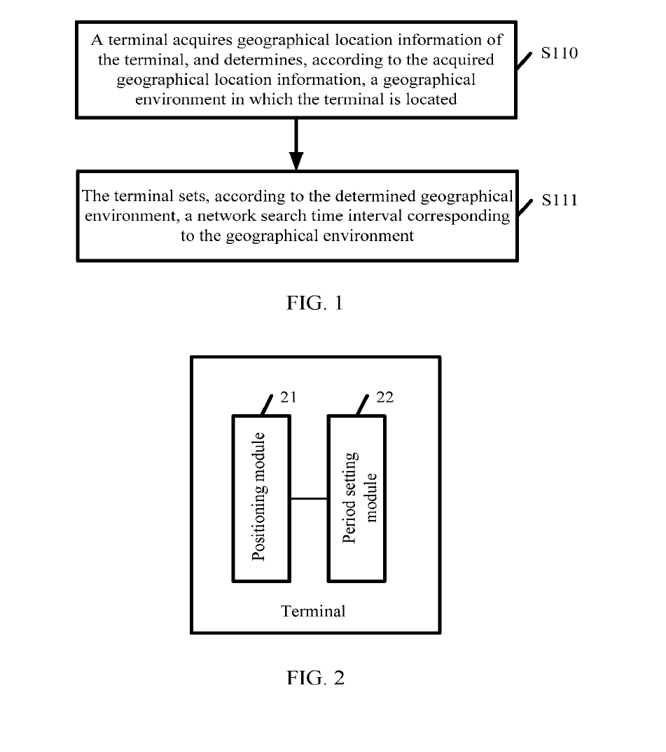

FIG. 1 is a schematic flowchart of an embodiment of a network search method for a terminal (terminal device) according to the present disclosure. As shown in FIG. 1, the method may include:

Step S110: A terminal acquires geographical location information of the terminal, and determines, according to the acquired geographical location information, a geographical environment in which the terminal is located.

Step S111: The terminal sets, according to the determined geographical environment, a network search time interval (the network search time interval may also be called a network search period) corresponding to the geographical environment.

During specific implementation, in step S110, the terminal may acquire geographical location information of the terminal by using a positioning system; and determine the geographical environment in which the terminal is located, according to the acquired geographical location information and a map that is stored locally on the terminal. The positioning system may be a Global Positioning System (GPS) or another positioning system that can operate when no mobile network is available to the terminal.

During specific implementation, in step S110, the terminal may start the positioning system to acquire the geographical location information of the terminal when the terminal fails to find a network according to a default network search period; the terminal may start the positioning system to acquire the geographical location information of the terminal when the terminal needs to search for a new network; or the terminal may start the positioning system to acquire the geographical location information of the terminal when the terminal is powered on and searches for a network.

During specific implementation, the geographical location information in this embodiment of the present disclosure may include latitude and longitude information or geographical coordinates. The locally stored map in this embodiment of the present disclosure may automatically return, according to the input latitude and longitude information or geographical coordinates, a name of the geographical environment corresponding to the latitude and longitude information or the geographical coordinates. Therefore, in step S110, the terminal may determine the geographical environment (for example, high mountains, deserts, seas, or an urban district) in which the terminal is located, according to a displayed geographical name (for example, the Himalayas, the Sahara Desert, the Dead Sea, and Shenzhen) that is stored locally on the terminal. During specific implementation, the locally stored map may be an offline map provided by a third party.

Certainly, during specific implementation, the map in this embodiment of the present disclosure may output, in another manner, data about the geographical environment in which the terminal is located, so that the terminal determines the geographical environment in which the terminal is located. In summary, in this embodiment of the present disclosure, the geographical environment in which the terminal is located can be determined by using the acquired geographical location information. The geographical location information in the present disclosure includes information used for describing a specific location of the terminal, such as latitude and longitude, and geographical coordinates. The geographical environment described in this embodiment of the present disclosure includes an environmental characteristics overview, such as a high mountain environment, a desert environment, and an urban environment, corresponding to a collection of climate, land, rivers, lakes, mountains, minerals, and flora and fauna resources that are related to the geographical location.

During specific implementation, in step S111, the terminal may determine whether the geographical environment belongs to a first geographical environment in which a network signal is less than a preset threshold. If it is determined that the geographical environment belongs to the first geographical environment in which the network signal is less than the preset threshold, the network search time interval for the terminal is set to be greater than a first time threshold. For example, network signals in geographical environments, such as mountains, seas, and deserts, are generally relatively weak. In this case, in step S111, it can be determined that these geographical environments belong to the first geographical environment in which the network signal is less than the preset threshold. In this case, the network search time interval for the terminal may be set to be greater than the first time threshold.

During specific implementation, in step S111, the terminal may determine whether the geographical environment belongs to a second geographical environment in which a network signal is greater than a preset threshold. If it is determined that the geographical environment belongs to the second geographical environment in which the network signal is greater than the preset threshold, the network search time interval for the terminal is set to be less than a second time threshold. For example, for a place with a relatively strong network signal, such as an urban district or home, the terminal can determine that the geographical environment belongs to the second geographical environment in which the network signal is greater than the preset threshold, and the terminal may set the network search time interval for the terminal to be less than the second time threshold. Certainly, during specific implementation, when it is determined that the geographical environment does not belong to the first geographical environment in which the network signal is less than the preset threshold, in this embodiment of the present disclosure, the network search time interval for the terminal may further be set to a system default value. Generally, the default value is less than the first time threshold. In this way, in this embodiment of the present disclosure, when a network signal is weak, a network search period may be extended, and an unnecessary network search operation may be avoided, so that electricity of the terminal is saved, and a purpose of extending a standby time of the terminal is achieved.

Specifically, the preset threshold, of the network signal, for determining whether the geographical environment belongs to the first geographical environment and the threshold, of the network signal, for determining whether the geographical environment belongs to the second geographical environment may be a same threshold, or may be different thresholds, which is not limited in this embodiment of the present disclosure.

During specific implementation, in this embodiment of the present disclosure, the second time threshold is set, and the set second time threshold may be less than the first time threshold. Therefore, in this embodiment of the present disclosure, a difference between a network search time interval for an area with a stronger network signal and a network search time interval for an area with a weaker network signal may be increased.

During specific implementation, in this embodiment of the present disclosure, when the network search period is set, specifically, a network search timer may be set to record duration of the network search period. If the timer expires, a network search operation is performed.

During specific implementation, in this embodiment of the present disclosure, the network search period may be set at a radio resource control protocol sublayer.

In addition, in this embodiment of the present disclosure, the method of the present disclosure may further include:

When the terminal detects that a backlight of screen is activated, a network search operation is performed. Advantages of the method are: a maximum demand of a user for using the terminal can be satisfied, and a case can be avoided in which the terminal cannot use a network in a long period of time because the set network search period is extremely long.

It can be seen from the above that in some feasible implementation manners of the present disclosure, a terminal acquires geographical location information of the terminal, and determines, according to the acquired geographical location information, a geographical environment in which the terminal is located; and the terminal sets, according to the determined geographical environment, a network search time interval corresponding to the geographical environment. Therefore, a network search time interval may be set flexibly according to a different geographical environment in which the terminal is located. Further, a relatively long network search time interval may be set when the geographical environment in which the terminal is located is a geographical environment with a relatively weak network signal; and a relatively short network search time interval may be set when the geographical environment in which the terminal is located is a geographical environment with a relatively strong network signal. Therefore, according to this embodiment of the present disclosure, power consumption of a battery of the terminal can be effectively reduced, and further a standby time of the terminal is effectively increased. Correspondingly, an embodiment of the present disclosure further provides a terminal device that can be used to implement the network search method for a terminal of the present disclosure. Structural composition of the terminal according to the embodiment of the present disclosure is described as follows by using an example.

FIG. 2 is a schematic diagram of structural composition of an embodiment of a terminal according to the present disclosure. As shown in FIG. 2, the terminal may include a positioning module 21 and a period setting module 22.

The positioning module 21 is configured to: acquire geographical location information of the terminal, and determine, according to the acquired geographical location information, a geographical environment in which the terminal is located.

The period setting module 22 is configured to set, according to the geographical environment determined by the positioning module 21, a network search time interval corresponding to the geographical environment.

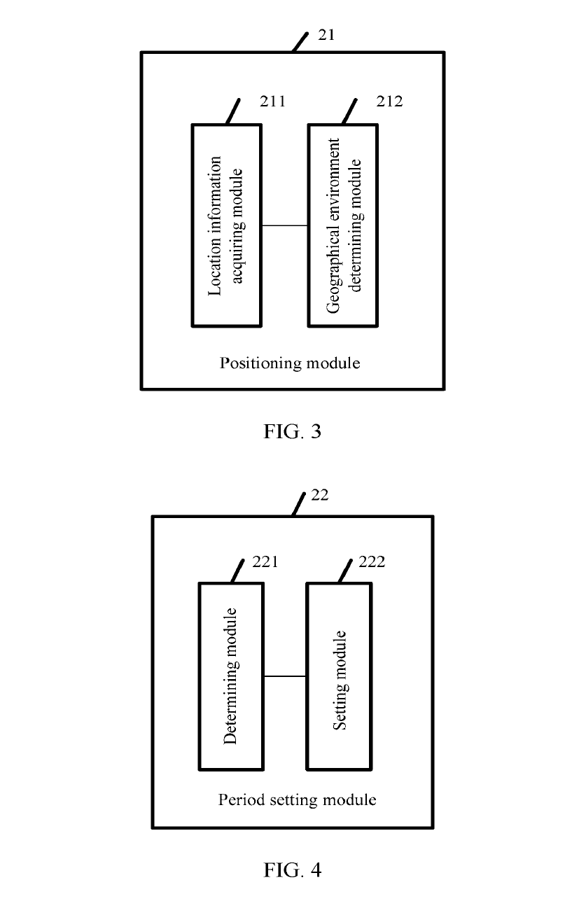

During specific implementation, as shown in FIG. 3, as a feasible implementation manner, the positioning module 21 may further include:

a location information acquiring module 211, configured to acquire geographical location information of the terminal by using a positioning system, where during specific implementation, the positioning system may be a Global Positioning System (GPS) or another positioning system that can operate when no mobile network is available to the terminal; and

a geographical environment determining module 212, configured to determine the geographical environment in which the terminal is located, according to the geographical location information acquired by the location information acquiring module 211 and a map that is stored locally on the terminal.

During specific implementation, the location information acquiring module 211 may start the positioning system to acquire the geographical location information of the terminal when network search performed according to a default network search period fails; the location information acquiring module may start the positioning system to acquire the geographical location information of the terminal when the terminal needs to search for a new network; or the location information acquiring module may start the positioning system to acquire the geographical location information of the terminal when the terminal is powered on and searches for a network.

During specific implementation, the geographical location information in this embodiment of the present disclosure may include latitude and longitude information or geographical coordinates. The locally stored map in this embodiment of the present disclosure may automatically return, according to the input latitude and longitude information or geographical coordinates, a name of the geographical environment corresponding to the latitude and longitude information or the geographical coordinates. Therefore, the geographical environment determining module 212 may specifically determine the geographical environment (for example, high mountains, deserts, seas, or an urban district) in which the terminal is located, according to a geographical name (for example, the Himalayas, the Sahara Desert, the Dead Sea, and Shenzhen) displayed on the map that is stored locally on the terminal.

Certainly, during specific implementation, the map in this embodiment of the present disclosure may also output, in another manner, data about the geographical environment in which the terminal is located, so that the terminal determines the geographical environment in which the terminal is located. In summary, in this embodiment of the present disclosure, the geographical environment in which the terminal is located can be determined by using the acquired geographical location information. During specific implementation, the locally stored map may be an offline map provided by a third party. The geographical location information in the present disclosure includes information used for describing a specific location of the terminal, such as latitude and longitude, and geographical coordinates. The geographical environment described in this embodiment of the present disclosure includes an environmental characteristics overview, such as a high mountain environment, a desert environment, and an urban environment, corresponding to a collection of climate, land, rivers, lakes, mountains, minerals, and flora and fauna resources that are related to the geographical location.

During specific implementation, as shown in FIG. 4, in some feasible implementation manners, the period setting module 22 may further include:

a determining module 221, configured to determine whether the geographical environment belongs to a first geographical environment in which a network signal is less than a preset threshold, and/or configured to determine whether the geographical environment belongs to a second geographical environment in which a network signal is greater than a preset threshold; and

a setting module 222, configured to: when the determining module 221 determines that the geographical environment belongs to the first geographical environment in which the network signal is less than the preset threshold, set the network search time interval for the terminal to be greater than a first time threshold. For example, network signals in geographical environments, such as mountains, seas, and deserts, are generally relatively weak. In this case, the determining module 221 can determine that these geographical environments belong to the first geographical environment in which the network signal is less than the preset threshold. In this case, the setting module 222 can set the network search time interval for the terminal to be greater than the first time threshold.

During specific implementation, the setting module 222 is further configured to: when the determining module 221 determines that the geographical environment belongs to the second geographical environment in which the network signal is greater than the preset threshold, set the network search time interval for the terminal to be less than a second time threshold. For example, for places with a relatively strong network signal, such as an urban district or home, the determining module 221 can determine that these geographical environments belong to the second geographical environment in which the network signal is greater than the preset threshold. In this way, the setting module 222 may set the network search time interval for the terminal to be less than the second time threshold. Certainly, during specific implementation, when the determining module 221 determines that the geographical environment does not belong to the first geographical environment in which the network signal is less than the preset threshold, the setting module 222 may further set the network search time interval for the terminal to a system default value. Generally, the default value is less than the first time threshold. In this way, in this embodiment of the present disclosure, when a network signal is weak, a network search period may be extended, and an unnecessary network search operation may be avoided, so that electricity of the terminal is saved, and a purpose of extending a standby time of the terminal is achieved.

Specifically, the preset threshold, of the network signal, for determining whether the geographical environment belongs to the first geographical environment and the threshold, of the network signal, for determining whether the geographical environment belongs to the second geographical environment may be a same threshold, or may be different thresholds, which is not limited in this embodiment of the present disclosure.

During specific implementation, in this embodiment of the present disclosure, the second time threshold is set, and the set second time threshold may be less than the first time threshold. Therefore, in this embodiment of the present disclosure, a difference between a network search time interval for an area with a stronger network signal and a network search time interval for an area with a weaker network signal may be increased.

During specific implementation, in this embodiment of the present disclosure, when the setting module 222 sets the network search period, specifically, a network search timer may be set to record duration of the network search period. If the timer expires, a network search operation is performed.

During specific implementation, in this embodiment of the present disclosure, the setting module 222 may set the network search period at a radio resource control protocol sublayer.

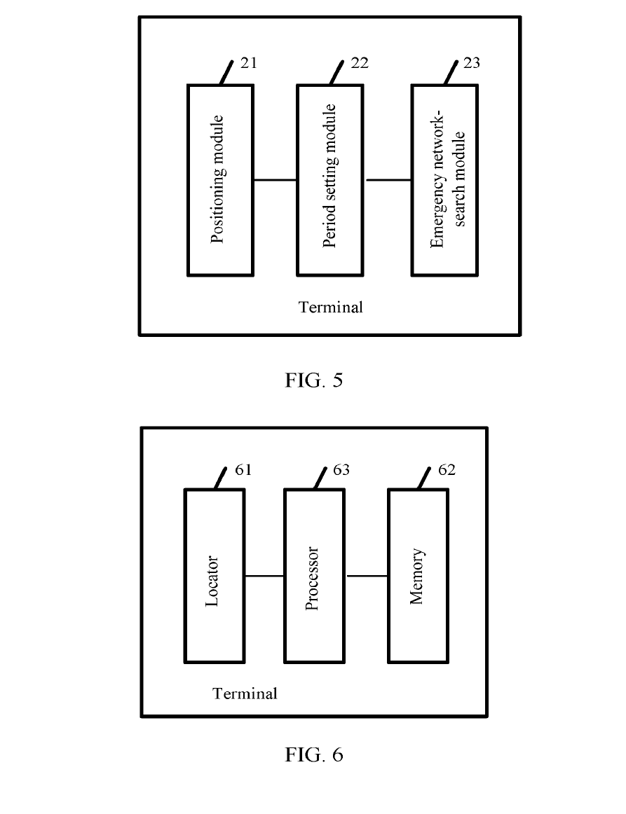

Further, as shown in FIG. 5, in another embodiment of the terminal according to the present disclosure, the terminal may further include:

an emergency network-search module 23, configured to: when the terminal detects that a backlight of screen is activated, perform a network search operation. Advantages of the module are: a maximum demand of a user for using the terminal can be satisfied, and a case can be avoided in which the terminal cannot use a network in a long period of time because the set network search period is extremely long.

It can be seen from the above that in some feasible implementation manners of the present disclosure, a terminal acquires geographical location information of the terminal, and determines, according to the acquired geographical location information, a geographical environment in which the terminal is located; and the terminal sets, according to the determined geographical environment, a network search time interval corresponding to the geographical environment. Therefore, a network search time interval may be set flexibly according to a different geographical environment in which the terminal is located. Further, a relatively long network search time interval may be set when the geographical environment in which the terminal is located is a geographical environment with a relatively weak network signal; and a relatively short network search time interval may be set when the geographical environment in which the terminal is located is a geographical environment with a relatively strong network signal. Therefore, according to this embodiment of the present disclosure, power consumption of a battery of the terminal can be effectively reduced, and further a standby time of the terminal is effectively increased.

FIG. 6 is a schematic diagram of structural composition of another embodiment of a terminal according to the present disclosure. As shown in FIG. 6, the terminal may include a locator 61 (locating circuit), a memory 62 (memory circuit), and a processor 63 (processing circuit).

The locator 61 is connected to the processor 63, and the processor 63 is connected to the memory 62.

The locator 61 is configured to acquire geographical location information of the terminal.

The processor 63 is configured to: execute a program stored in the memory 62; determine, according to the acquired geographical location information, a geographical environment in which the terminal is located; and set, according to the determined geographical environment, a network search time interval corresponding to the geographical environment.

In some feasible implementation manners, that the processor 63 determines, according to the acquired geographical location information, a geographical environment in which the terminal is located includes:

the processor 63 determines the geographical environment in which the terminal is located, according to the geographical location information acquired by the locator 61 and a map that is stored in the memory 62.

In some feasible implementation manners, the geographical location information includes latitude and longitude information or geographical coordinates.

That the processor 63 determines the geographical environment in which the terminal is located, according to the geographical location information acquired by the locator 61 and a map that is stored in the memory 62 includes:

the processor 63 acquires, according to the latitude and longitude information and the map that is stored in the memory 62, a geographical name that is on the map and corresponding to the latitude and longitude information, and determines, according to the geographical name, the geographical environment in which the terminal is located; or

the processor 63 acquires, according to the geographical coordinates and the map that is stored in the memory 62, a geographical name that is on the map and corresponding to the geographical coordinates, and determines, according to the geographical name, the geographical environment in which the terminal is located.

In some feasible implementation manners, that the processor 63 sets, according to the determined geographical environment, a network search time interval corresponding to the geographical environment includes:

the processor 63 determines whether the geographical environment belongs to a first geographical environment in which a network signal is less than a preset threshold, and/or is configured to determine whether the geographical environment belongs to a second geographical environment in which a network signal is greater than a preset threshold; and

when it is determined that the geographical environment belongs to the first geographical environment in which the network signal is less than the preset threshold, the processor 63 sets the network search time interval for the terminal to be greater than a first time threshold; and when it is determined that the geographical environment belongs to the second geographical environment in which the network signal is greater than the preset threshold, the processor 63 sets the network search time interval for the terminal to be less than a second time threshold.

Specifically, in this implementation manner, the processor may determine both whether the geographical environment belongs to the first geographical environment in which the network signal is less than the preset threshold and whether the geographical environment belongs to the second geographical environment in which the network signal is greater than the preset threshold. The processor may also determine only one of the possibilities, for example, determine only whether the geographical environment belongs to the first geographical environment in which the network signal is less than the preset threshold, without determining on whether the geographical environment belongs to the second geographical environment.

In some feasible implementation manners, the terminal further includes a touchscreen (not shown in the figure). The processor 63 is further configured to: when it is detected that the touchscreen is lighted up (e.g., a back light is turned on), perform a network search operation.

The network search apparatus disclosed in the present disclosure may be made into an independent apparatus, or be integrated into various terminals, such as a mobile phone, a tablet personal computer, laptop computer, a multimedia player, a digital camera, a personal digital assistant (PDA for short), a navigation apparatus, a mobile Internet device (MID), or a wearable device, which is not limited in this embodiment of the present disclosure.

In addition, this embodiment of present disclosure further provides a computer storage medium. The computer storage medium may store a program. When the program is executed, some or all steps of the method described in the embodiments of the present disclosure may be executed.

It should be noted that same or corresponding technical features in the embodiments of the present disclosure may be cross-referred.

Obviously, a person skilled in the art can make various modifications and variations to the present disclosure without departing from the spirit and scope of the present disclosure. The present disclosure is intended to cover these modifications and variations provided that they fall within the scope of protection defined by the following claims and their equivalent technologies.

1-16. (canceled)

17: A network search method, comprising:
acquiring, by a terminal, geographical location information of the terminal;
determining, by the terminal, geographical environment in which the terminal is located according to the acquired geographical location information; and
setting, by the terminal, a network search time interval corresponding to the geographical environment according to the determined geographical environment.

18: The network search method according to claim 17, wherein the acquiring, by the terminal, the geographical location information of the terminal comprises:
acquiring the geographical location information of the terminal using a positioning system.

19: The network search method according to claim 17, wherein the determining, by the terminal, the geographical environment in which the terminal is located according to the acquired geographical location information comprises:
determining, by the terminal, the geographical environment in which the terminal is located according to the acquired geographical location information and a map that is stored in the terminal.

20: The network search method according to claim 19, wherein the determining, by the terminal, the geographical environment in which the terminal is located according to the acquired geographical location information and the map that is stored in the terminal comprises:
determining a geographical name according to at least one of latitude and longitude information, and/or the geographical coordinates on the map; and
determining the geographical environment in which the terminal is located according to the geographical name.

21: The network search method according to claim 17, wherein the setting, by the terminal, the network search time interval corresponding to the geographical environment according to the determined geographical environment comprises at least one of:
setting the network search time interval for the terminal to be greater than a first time threshold when the geographical environment belongs to a first geographical environment in which a network signal is less than a preset threshold; and/or
setting the network search time interval for the terminal to be less than a second time threshold when the geographical environment belongs to a second geographical environment in which a network signal is greater than a preset threshold.

22: The network search method according to claim 17, further comprising:
performing a network search operation when the terminal detects that a screen is lighted up.

23: A terminal comprising a locator, and a processor; wherein
the locator is configured to acquire geographical location information of the terminal; and
the processor is configured to:
determine geographical environment in which the terminal is located according to the acquired geographical location information; and
set a network search time interval corresponding to the geographical environment according to the determined geographical environment.

24: The terminal according to claim 23, wherein the terminal comprises a memory configured to store a map, and the processor is further configured to:
determine the geographical environment in which the terminal is located, according to the geographical location information acquired by the locator and the map that is stored in the memory.

25: The terminal according to claim 24, wherein
the processor is further configured to acquire a geographical name that is on the map corresponding to latitude and longitude information, and determine the geographical environment in which the terminal is located according to the geographical name.

26: The terminal according to claim 24, wherein
the processor is further configured to acquire a geographical name that is on the map corresponding to geographical coordinates, and determines the geographical environment in which the terminal is located according to the geographical name.

27: The terminal according to claim 23, wherein the processor is further configured to:
determine whether the geographical environment belongs to a first geographical environment in which a network signal is less than a preset threshold; and
set the network search time interval for the terminal to be greater than a first time threshold when the geographical environment belongs to the first geographical environment.

28: The terminal according to claim 23, wherein the processor is further configured to:
determine whether the geographical environment belongs to a second geographical environment in which a network signal is greater than a preset threshold; and
set the network search time interval for the terminal to be less than a second time threshold when the geographical environment belongs to the second geographical environment.

29: The terminal according to claim 23, wherein the terminal further comprises a screen, and the processor is further configured to perform a network search operation when the screen is lighted up.

30: A non-transitory computer readable medium storing instructions for causing a processor in a terminal device to execute operations for a network search, the operations comprising:
acquiring geographical location information of the terminal device;
determining geographical environment in which the terminal device is located according to the acquired geographical location information; and
setting a network search time interval corresponding to the geographical environment according to the determined geographical environment.

31: The non-transitory computer readable medium according to claim 30, wherein the operation of acquiring the geographical location information of the terminal device comprises:
acquiring the geographical location information of the terminal device using a positioning system.

32: The non-transitory computer readable medium according to claim 30, wherein the operation of determining the geographical environment in which the terminal device is located according to the acquired geographical location information comprises:
determining the geographical environment in which the terminal device is located according to the acquired geographical location information and a map that is stored in the terminal.

33: The non-transitory computer readable medium according to claim 32, wherein the operation of determining the geographical environment in which the terminal device is located according to the acquired geographical location information and the map that is stored in the terminal device comprises:
determining a geographical name according to at least one of latitude and longitude information, and/or geographical coordinates on the map; and
determining the geographical environment in which the terminal device is located according to the geographical name.

34: The non-transitory computer readable medium according to claim 30, wherein the operation of setting the network search time interval corresponding to the geographical environment according to the determined geographical environment comprises at least one of:
setting the network search time interval for the terminal device to be greater than a first time threshold when the geographical environment belongs to a first geographical environment in which a network signal is less than a preset threshold; and/or
setting the network search time interval for the terminal device to be less than a second time threshold when the geographical environment belongs to a second geographical environment in which a network signal is greater than a preset threshold.

35: The non-transitory computer readable medium according to claim 30, the operations further comprising:
performing a network search operation when the terminal device detects that a screen is lighted up.
